(19) United States
(12) Patent Application Publication
(10) Pub. No.: US 2021/0247236 A1
(43) Pub. Date: Aug. 12, 2021

(54) TEMPERATURE MEASURING DEVICE FOR CONTAINER

(71) Applicant: K-Jump Health Co., Ltd., New Taipei City (TW)

(72) Inventor: Chao-Man TSENG, New Taipei City (TW)

(21) Appl. No.: 16/837,708

(22) Filed: Apr. 1, 2020

(30) Foreign Application Priority Data
Feb. 7, 2020 (TW) 109201386

(51) Int. Cl. G01K 1/02; G01K 1/14; G01K 7/42

(52) U.S. Cl. CPC G01K 1/024; G01K 7/42; G01K 1/143

(57) ABSTRACT

A temperature measuring device installed to a mouth (11) of a container (10) for sensing the temperature inside the container (10) includes a hanger (100) mounted onto the mouth (11), a temperature sensing element (200), a temperature sensing module, a wireless communication module, and an antenna (500). The temperature sensing element (200) is suspended from the hanger (100); the temperature sensing module is installed to the hanger (100) and electrically connected to the temperature sensing element (200); the wireless communication module is installed to the hanger (100) and electrically connected to temperature sensing module; and the antenna (500) is embedded into the hanger (100) and electrically coupled to the wireless communication module. The temperature sensing element (200) suspended from the container (10) can measure the temperature of a liquid contained in the container (10), and the measured data can be outputted through the wireless communication module.

### BACKGROUND OF THE INVENTION

### 1. Technical Field

The technical field relates to a temperature measuring device, and more particularly to a universal temperature measuring device for a container.

### 2. Description of Related Art

In general, an open container can receive a thermometer to measure the temperature of the liquid contained in the container. However, a closed container attached with a lid such as a milk bottle may not be inserted with a thermometer directly, and it is relatively difficult to measure or estimate the temperature of the liquid contained in the closed container accurately by touching the liquid. Furthermore, the temperature of an outer wall of the container is very different from the actual temperature of the liquid contained in the container, and estimating the temperature by touching may cause burns while drinking the liquid.

In view of the aforementioned drawbacks of the prior art, the discloser of this disclosure based on years of experience in the related industry to conduct extensive research and experiment, and finally provided a feasible solution to overcome the drawbacks of the prior art.

### SUMMARY OF THE INVENTION

Therefore, it is a primary object of this disclosure to provide a universal temperature measuring device for a container to overcome the drawbacks of the prior art.

To achieve the aforementioned and other objectives, this disclosure provides a temperature measuring device, installed to a mouth of a container for sensing the temperature inside the container, comprises a hanger mounted onto the mouth, a temperature sensing element, a temperature sensing module, a wireless communication module, and an antenna, wherein the temperature sensing element is suspended from the hanger, and the temperature sensing module is installed to the hanger and electrically coupled to the temperature sensing element, and the wireless communication module is installed to the hanger and electrically coupled to the temperature sensing module, and the antenna is embedded into the hanger and electrically coupled to the wireless communication module.

In the temperature measuring device of this disclosure, the hanger comprises an outer ring mounted onto the mouth, and at least a part of the antenna is extended along the interior of the outer ring. An elastic ring rib is formed on a side surface of the outer ring. The hanger has an inner support leg formed on and inwardly extended from the outer ring, and an end of the inner support leg is formed into a fixed seat, and the wireless communication module is embedded into the fixed seat, and the antenna is extended along the interior of the inner support leg and coupled to the wireless communication module. The temperature sensing module is embedded into the fixed seat. The temperature sensing element comprises a tube, a pair of conducting wires and a thermistor electrically coupled to the pair of conducting wires, and an end of the tube is fixed to the fixed seat, and the pair of conducting wires and the thermistor are installed in the tube, and the pair of conducting wires are electrically coupled to the temperature sensing module. The inner support leg has a plural quantity, and an end of the inner support legs is coupled to the fixed seat, and the inner support legs are arranged into the form of a cone, and the other end of the tube is extended away from the outer ring. The tube is open at an end to form an open end provided for passing the pair of conducting wires, and the tube has an outer flange formed and protruded sideway from the open end, and the outer flange is embedded into the fixed seat. The outer flange is attached and installed with a sealing ring, and the fixed seat covers the sealing ring, and the sealing ring is sheathed onto the tube.

In the temperature measuring device of this disclosure, the temperature sensing element is suspended from the container through the hanger and provided for measuring the temperature of the liquid contained in the container, and the measured data can be outputted through the wireless communication module.

### BRIEF DESCRIPTION OF THE DRAWINGS

FIG. 1 is a perspective view of a temperature measuring device for a container in a using status in accordance with a preferred embodiment of this disclosure;

FIG. 2 is a perspective view of a temperature measuring device for a container in accordance with a preferred embodiment of this disclosure;

FIG. 3 is a cross-sectional view of a temperature measuring device for a container in accordance with a preferred embodiment of this disclosure; and

FIG. 4 is a cross-sectional view of a temperature measuring device for a container in a using status in accordance with a preferred embodiment of this disclosure.

### DESCRIPTION OF THE PREFERRED EMBODIMENTS

The technical contents of this disclosure will become apparent with the detailed description of preferred embodiments accompanied with the illustration of related drawings as follows. It is intended that the embodiments and drawings disclosed herein are to be considered illustrative rather than restrictive.

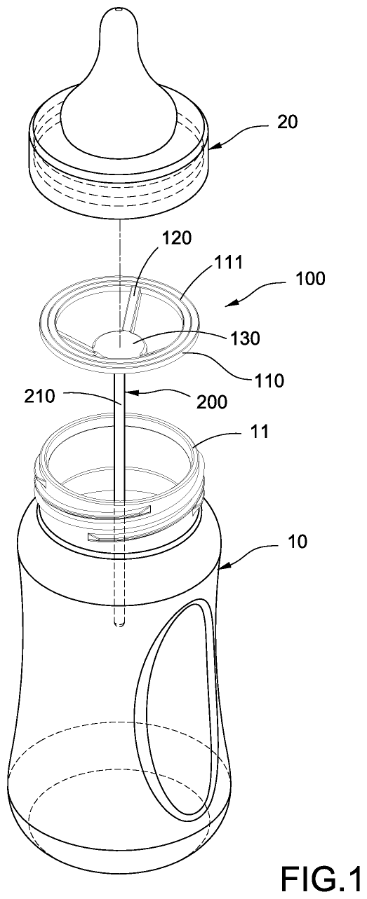

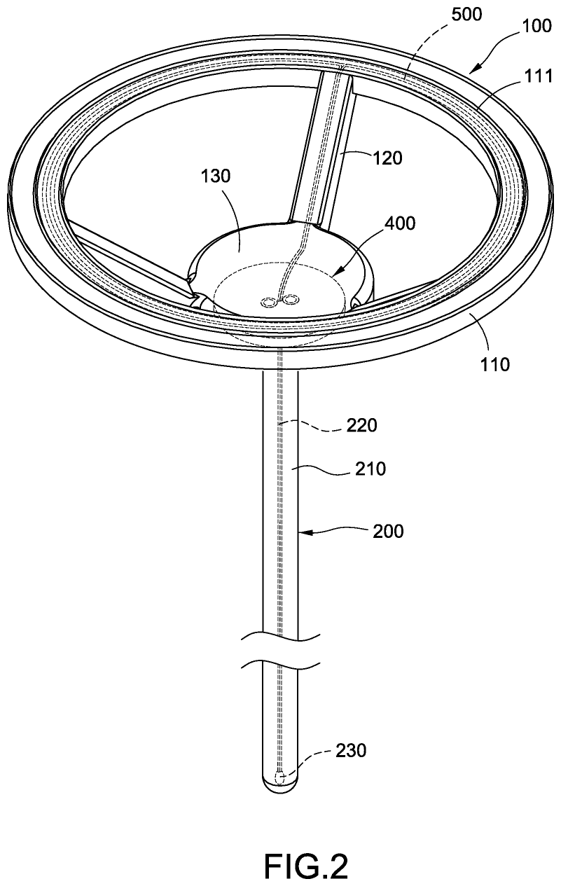

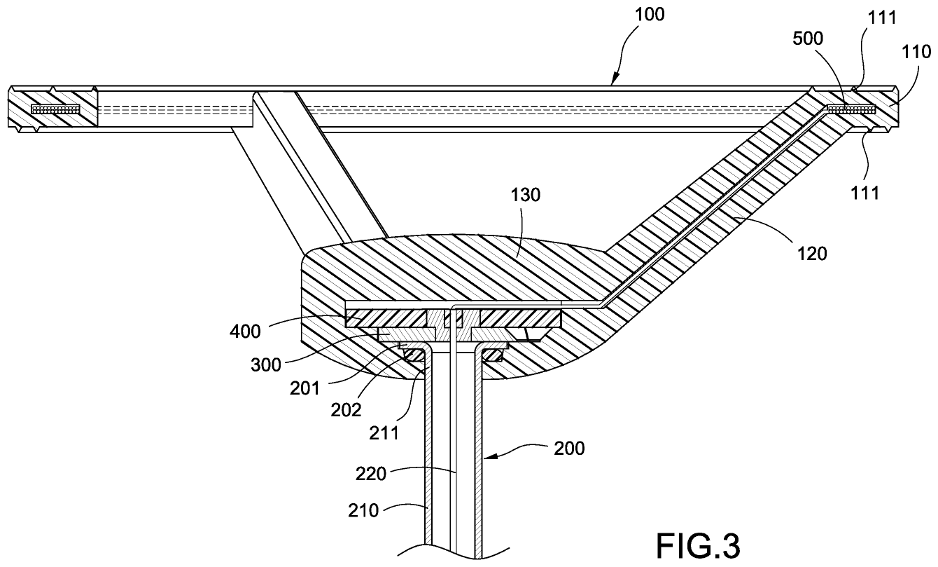

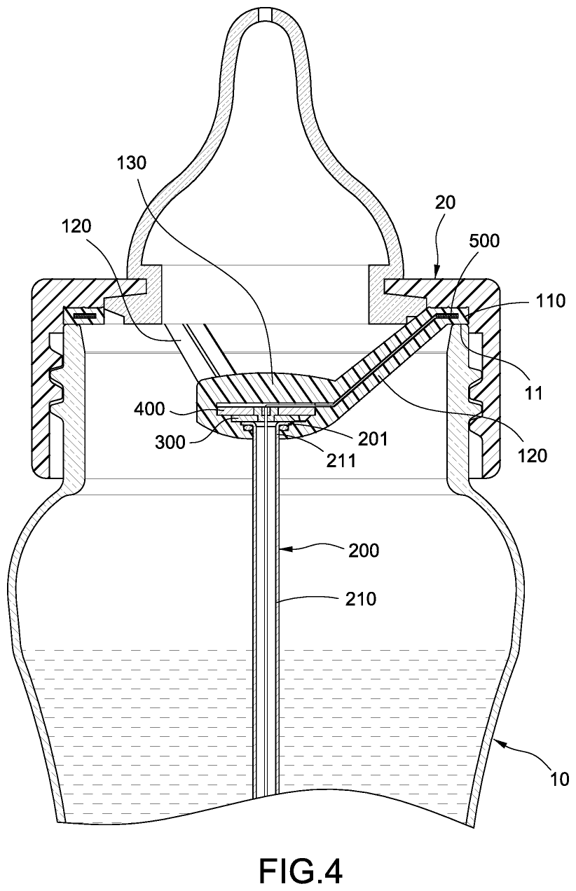

With reference to FIGS. 1 to 4 for a temperature measuring device for a container 10 in accordance with a preferred embodiment of this disclosure, the temperature measuring device is installed to a mouth 11 of a container 10 for sensing the temperature of a liquid contained in the container 10. In this embodiment of the present disclosure, the temperature measuring device comprises a hanger 100, a temperature sensing element 200, a temperature sensing module (not shown in the figure), a wireless communication module (not shown in the figure), and an antenna 500.

In this embodiment, the temperature sensing module and the wireless communication module are printed circuits installed on a same circuit board 400, and they are not labelled with numerals. Of course, the temperature sensing module and the wireless communication module can also be printed on different circuit boards respectively.

The hanger 100 is mounted onto the mouth 11. Specifically, the hanger 100 is made by plastic injection molding, and comprises an outer ring 110, and the hanger 100 has at least one inner support leg 120 formed and inwardly extended from the outer ring 110, and an end of the inner support leg 120 is formed into a fixed seat 130. The outer ring 110 has an effect of being mounted onto the mouth 11, and the inner support leg 120 has an effect of being positioned at the fixed seat 130, so that the simplest implementation just requires a single inner support leg 120 to achieve the effect of positioning the fixed seat 130. However, plural inner support legs 120 are adopted in a preferred embodiment, and an end of the inner support legs 120 is coupled to the fixed seat 130. The inner support legs 120 are arranged into the form of a cone, so that when the hanger 100 is installed into the container 10, the tip of the cone is passed through the mouth 11 and then into the container 10, and the outer ring 110 can be positioned by the inner support legs 120 arranged into the form of a cone to facilitate the its precise alignment with the mouth 11. The inner support legs 120 arranged into the form of a cone and inwardly extended towards the container 10 can avoid blocking the using space of the mouth 11. Therefore, the plurality of the inner support leg 120 has a better effect that that of the single inner support leg 120.

In this embodiment, the hanger 100 is made of a hard-plastic material and used for a support purpose, and at least one elastic ring rib 111 made of a double portion of a soft plastic material is formed and protruded from at least one side surface of the outer ring 110. In a preferred embodiment, both sides of the outer ring 110 have a plurality of elastic ring ribs 111. When the mouth 11 is closed by a bottle cap 20, the outer ring 110 is clamped between the mouth 11 and the bottle cap 20, and the elastic ring ribs 111 disposed at the upper and lower sides of the outer ring 110 are compressed and deformed by the bottle cap 20 and the mouth 11 to seal the mouth 11 with the bottle cap 20, and the plurality of concentric elastic ring ribs 111 can be used universally for containers 10 of different diameters.

The temperature sensing element 200 is suspended from the hanger 100. The temperature sensing element 200 comprises a tube 210, a pair of conducting wires 220 and a thermistor 230 electrically coupled to the pair of conducting wires 220, and the tube 210 is made of metal, and an end of the tube 210 is fixed to the fixed seat 130, and the pair of conducting wires 220 and the thermistor 230 are installed in the tube 210, and the pair of conducting wires 220 are electrically coupled to the temperature sensing module. The other end of tube 210 is extended in a direction away from the outer ring 110. The tube 2 is open at an end to form an open end 211 provided for passing the pair of conducting wires 220, and an outer flange 201 is formed and protruded from the open end 211 of the tube 210 and embedded into the fixed seat 130. A pad 300 is clamped between one of the sides of the outer flange 201 and the circuit board 400 to provide an insulation effect between the tube 210 and the circuit board 400; and a sealing ring 202 is attached to the other side of the outer flange 201. Specifically, the sealing ring 202 is sheathed on the tube 210, and the fixed seat 130 covers the sealing ring 202 so as to seal the joint between the temperature sensing element 200 and the hanger 100 to prevent water from entering into the hanger 100.

The temperature sensing module is installed to the hanger 100 and electrically coupled to the temperature sensing element 200. Specifically, the temperature sensing module of this embodiment is installed onto the circuit board 400, and the circuit board 400 is embedded into the fixed seat 130, and the conducting wire 220 is coupled to the circuit board 400, so that the temperature sensing module is electrically coupled to conducting wire 220.

The wireless communication module is installed to the hanger 100 and electrically coupled to the temperature sensing module. Specifically, the wireless communication module is embedded into the fixed seat 130, and the wireless communication module of this embodiment at least has a near-field communication (NFC) function. Of course, the wireless communication module can also have other communication functions (such as the radio frequency identification (RFID) function and this disclosure is not limited to the aforementioned functions only.

The antenna 500 is embedded into the hanger 100 and electrically coupled to the wireless communication module and provided for purpose of near-field communications. In this embodiment, at least a part of the antenna 500 is extended along the interior of the outer ring 110, and the antenna 500 is extended along the interior of the inner support leg 120 into the fixed seat 130 and coupled to the wireless communication module. In a preferred embodiment, the antenna 500 extends along the outer ring 110 in the shape of a ring and passes through one of the inner support legs 120 into the fixed seat 130 to connect the circuit board 400 and electrically connect the wireless communication module of the circuit board 400.

In the temperature measuring device of this disclosure, the temperature sensing element 200 is suspended in the container 10 by the hanger 100, and the thermistor 230 of the temperature sensing element 200 is installed to the bottom of the container 10 through the tube 210 and provided for measuring the temperature of a liquid contained in the container 10. The temperature sensing module can obtain temperature data by the temperature sensing element 200. The antenna 500 is provided for facilitating users to connect a mobile device to a wireless communication module via wireless communication. Therefore, the temperature data obtained by the temperature sensing module can be outputted through the wireless communication module. As to users, the users simply need to place the mobile device with an NFC communication function near the mouth 11 of the container 10 in order to obtain the temperature data of the liquid contained in the container 10. The antenna 500 is extended along the outer ring 110 in the form of a ring, so that the users can sense the mobile device from any side of the container 10 to facilitate the sensing operation. In addition, the space between the outer ring 110 and the inner support leg 120 is provided for the liquid to pass through, so that the hanger 100 mounted onto the mouth 11 will not block the liquid from passing into or exiting from the container 10.

While this disclosure has been described by means of specific embodiments, numerous modifications and variations could be made thereto by those skilled in the art without departing from the scope and spirit of this disclosure set forth in the claims.

What is claimed is:

1. A temperature measuring device, installed to a mouth (11) of a container (10) for sensing the temperature inside the container (10), comprising a hanger (100) mounted onto the mouth (11), a temperature sensing element (200), a temperature sensing module, a wireless communication module and an antenna (500), and the temperature sensing element (200) being suspended from the hanger (100), and the temperature sensing module being installed to the hanger (100) and electrically coupled to the temperature sensing element (200), and the wireless communication module being installed to the hanger (100) and electrically coupled to the temperature sensing module, and the antenna (500) being embedded into the hanger (100) and electrically coupled to the wireless communication module.

2. The temperature measuring device as claimed in claim 1, wherein the hanger (100) comprises an outer ring (110) mounted onto the mouth (11), and at least a part of the antenna (500) is extended along the interior of the outer ring (110).

3. The temperature measuring device as claimed in claim 2, wherein the outer ring (110) has an elastic ring rib (111) formed on a side surface thereof.

4. The temperature measuring device as claimed in claim 2, wherein the hanger (100) has an inner support leg (120) formed on and inwardly extending from the outer ring (110), and an end of the inner support leg (120) is formed into a fixed seat (130), and the wireless communication module is embedded into the fixed seat (130), and the antenna (500) is extended along the interior of the inner support leg (120) and coupled to the wireless communication module.

5. The temperature measuring device as claimed in claim 4, wherein the temperature sensing module is embedded into the fixed seat (130).

6. The temperature measuring device as claimed in claim 4, wherein the temperature sensing element (200) comprises a tube (210), a pair of conducting wires (220) and electrically coupled to a thermistor (230) of the pair of conducting wires (220), and an end of the tube (210) is fixed to the fixed seat (130), and the pair of conducting wires (220) and the thermistor (230) are installed in the tube (210), and the pair of conducting wires (220) are electrically coupled to the temperature sensing module.

7. The temperature measuring device as claimed in claim 6, wherein inner support leg (120) is in a plural quantity, and an end of the inner support legs (120) is coupled to the fixed seat (130), and the inner support legs (120) are arranged into the form of a cone, and other end of the tube (210) is extended away from the outer ring (110).

8. The temperature measuring device as claimed in claim 6, wherein the tube (210) is substantially open at a single end to form an open end (211) provided for passing the pair of conducting wires (220), and the tube (210) has an outer flange (201) formed and protruded sideway from the open end (211), and the outer flange (201) is embedded into the fixed seat (130).

9. The temperature measuring device as claimed in claim 8, wherein the outer flange (201) is attached and installed with a sealing ring (202), and the fixed seat (130) covers the sealing ring (202).

10. The temperature measuring device as claimed in claim 9, wherein the sealing ring (202) is sheathed on the tube (210).
